(19) United States
(12) Patent Application Publication
(10) Pub. No.: US 2006/0040674 A1
(43) Pub. Date: Feb. 23, 2006

(54) User class provisioning for R-PDCH via a single common rate control sub-channel

(75) Inventors: Rath Vannithamby, San Diego, CA (US); Tao Wu, Carlsbad, CA (US); Patrick A. Hosein, San Diego, CA (US); Young C. Yoon, San Diego, CA (US); Shiau-He Shawn Tsai, San Diego, CA (US); Anthony C.K. Soong, Superior, CO (US); Wanshi Chen, San Diego, CA (US)

Correspondence Address: COATS & BENNETT, PLLC, P O BOX 5, RALEIGH, NC, 27602, US

(73) Assignee: Telefonaktiebolaget L.M. Ericsson (publ)

(21) Appl. No.: 11/027,315

(22) Filed: Dec. 31, 2004

Related U.S. Application Data
(60) Provisional application No. 60/592,897, filed on Jul. 29, 2004.

(51) Int. Cl. H04Q 7/20

(52) U.S. Cl. 455/452.2

(57) ABSTRACT

Users in a wireless communication system are provisioned into QoS-based classes and rate controlled using a single, per-sector common rate control (CRC) sub-channel. In one or more embodiments, different mobile stations are configured to respond differently to the same CRC commands by provisioning them with different Traffic-to-Pilot Ratio (TPR) tables and/or with different TPR step size adjustment tables. That is, the network can define different classes or groups of mobile stations by sending class or group-specific TPR-related values to the mobile stations belonging to a specific class or group. With this method, the mobile stations in one group can achieve different reverse link data rates, or make more aggressive data rate changes, than those in another group, even though both groups receive the same rate control commands.

### RELATED APPLICATIONS

This application claims priority to Provisional U.S. Patent Application 60/592,897 filed Jul. 29, 2004, which is incorporated herein by reference.

### BACKGROUND

The present invention relates generally to the field of wireless communication systems and in particular to a system and method of user class provisioning for a reverse link packet data channel using per-sector common rate control commands.

Wireless communications systems have evolved from providing circuit-switched analog voice services, to circuit-switched analog and digital voice and data services, and most recently to packet-switched digital voice and data services. In particular, Revision C of the IS-2000 standard protocol added provisions for high-speed, forward link (base station to mobile station) packet data functionality, and Revision C of IS-2000 adds high-speed reverse link (mobile station to base station) functionality. This is the latest development in 1xEV-DV (1x radio transmission technology EVolution for high-speed integrated Data and Voice).

The diverse applications that will be offered in a 1xEV-DV network (e.g., voice, audio, images, video, web browsing, and the like) will place differing Quality of Service (QoS) requirement upon the network. Furthermore, the applications are likely to have different QoS requirements on the forward channel than on the reverse channel. Accordingly, the 1xEV-DV protocol includes a flexible Media Access Control (MAC) mechanism that allows the base station to have different levels of control over the resources used by the mobile station. For example, under 1xEV-DV, the base station may control the data rate of mobile stations, e.g., on the reverse packet data channel (R-PDCH) using a variety of methods, including Autonomous rate, per-sector and per-group Common Rate Control (CRC), Dedicated Rate Control (DRC) and Grant assignments.

For ease of control, it is often desirable to define classes of users in terms of their QoS requirements. For example, mobile stations transmitting video on the R-PDCH may require high throughput, low latency, and low error rates. Mobile stations engaged in bursty data communications, such as web browsing, may have lower throughput requirements, but require low latency. Other packet data communications, such as Voice over Internet Protocol (VoIP) may tolerate higher latency and a best-effort commitment on data throughput and error rates. The users employing these applications may be grouped, or provisioned, into classes, such as Gold, Silver and Bronze users, respectively. Each class or group may then be allocated radio resources together, easing the system management task.

One parameter that may be advantageously managed through user class provisioning is a mobile station's data rate on the R-PDCH. The traditional approach to class-based rate control is to assign each mobile station in a QoS class to a per-group CRC sub-channel. However, this consumes forward link radio resources, as a separate rate control sub-channel is required for each class of users. The use of per-sector (CRC) commands minimizes forward link radio resources, using only one rate control sub-channel to broadcast rate control commands for all mobile stations in the sector. However, according to prior art techniques, there is no way to implement user class provisioning with per-sector CRC commands, as all mobile stations in the sector respond to the CRC commands similarly.

### SUMMARY

The present invention provides a method and apparatus to achieve different reverse link rate control behavior for different mobile stations receiving the same reverse link rate control commands, based on transmitting different configuration values to different ones of the mobile stations. The configuration values, which may comprises class or group-specific values stored by the network, correspond to different reverse link rate control command response behaviors, such that sending different configuration values to different mobile stations effectively results in those mobile stations responding differently to the same reverse link rate control commands, allowing the network to “create” groups of classes of mobile stations with different grades or quality of reverse link service without having to send different reverse link command sets.

Thus, one or more embodiments provide user class provisioning for a reverse traffic channel in a wireless communication system supporting a plurality of mobile stations, wherein at least two classes of users are defined. A first user is assigned to a first class by transmitting a first predetermined value to the first user's mobile station. A second user is assigned to a second class by transmitting a second, different predetermined value to the second user's mobile station. Reverse link traffic is managed by issuing per-sector common rate control (CRC) commands, the first user's mobile station responding differently to the CRC commands than the second user's mobile station in response to the predetermined values. That is, different users' mobile stations can be made to respond differently to the CRC commands based on sending different predetermined (configuration) values to individual mobile stations, or to groups of mobile stations.

The present invention also relates to a method of selective group rate control for a reverse traffic channel in a wireless communication system including a plurality of mobile stations. A predetermined value is transmitted to a select subset of the plurality of mobile stations. Per-sector common rate control (CRC) commands are issued that are operative to alter the data rate of the subset of mobile stations differently than the data rate of others of the plurality of mobile stations in response to the predetermined value.

The present invention additionally relates to a wireless communication system. The system includes a plurality of mobile stations, each including a TPR table and a TPR step size table, and each operative to transmit packet data on a reverse packet data channel (R-PDCH) at a rate dynamically determined by the rate control commands received by the mobile station and the values in the TPR and TPR step size tables. The system also includes at least one base station issuing per-sector common rate control (CRC) commands in at least one sector to control the R-PDCH data rates of one or more mobile stations being supported by the base station, and to effect different reverse link rate control command responses among different ones of the mobile stations by altering the TPR tables and/or TPR adjustment step size table values in different ones of the mobile stations. Such alterations may be made based on the class or group affiliations of the different mobile stations. Mobile stations having different TPR-related configuration values respond differently to the same reveres link rate control commands, and thus operate with differing reverse link rate control performance.

### BRIEF DESCRIPTION OF DRAWINGS

FIG. 1 is a functional block diagram of a wireless communication system.

FIG. 2 is a flow diagram of a method of user class provisioning using per-sector common rate control.

FIG. 3 is a flow diagram of adjusting a reverse link data rate in response to a per-sector common rate control command and configured table values.

### DETAILED DESCRIPTION

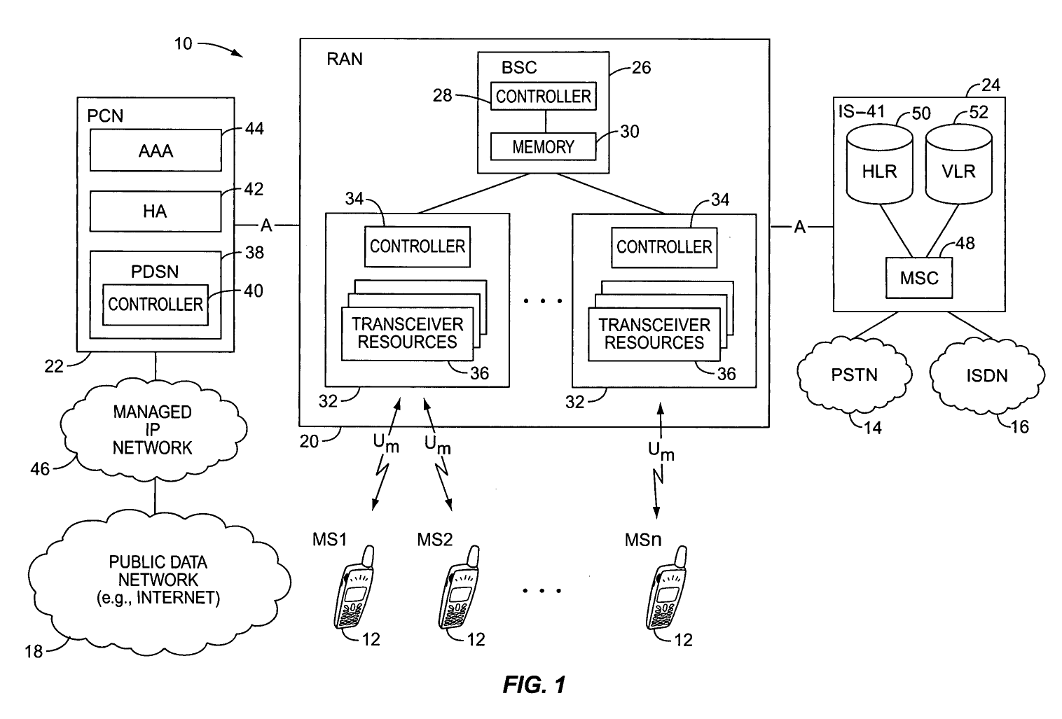

FIG. 1 illustrates an exemplary wireless communication network generally referred to by the numeral 10. In an exemplary embodiment, network 10 is based on cdma2000, 1xEV-DV standards as promulgated by the Telecommunications Industry Association (TIA), although the present invention is not limited to such implementations. Here, network 10 communicatively couples one or more mobile stations (MSs) 12 to the Public Switched Telephone Network (PSTN) 14, the Integrated Data Services Network (ISDN) 16, and/or a Public Data Network (PDN) 18, such as the Internet. In support of this functionality, the network 10 comprises a Radio Access Network (RAN) 20 connected to a Packet Core Network (PCN) 22 and an IS-41 network 24.

The RAN 20 typically comprises one or more Base Station Controllers (BSCs) 26, each including one or more controllers 28 or other processing systems, with associated memory 30 for storing necessary data and parameters relating to ongoing communications activity. Generally, each BSC 26 is associated with one or more Base Stations (BSs) 32. Each BS 32 comprises one or more controllers 34, or other processing systems, and assorted transceiver resources 36 supporting radio communication with MSs 12, such as modulators/demodulators, baseband processors, radio frequency (RF) power amplifiers, antennas, etc.

BSs 32 may be referred to as Base Transceiver Systems (BTSs) or Radio Base Stations (RBSs). In operation, BSs 32 transmit control and traffic data to MSs 12 on forward link channels, and receive control and traffic data from them over on reverse link channels. The BSs 32 may perform power control on the MSs 12 according to a variety of methods. BSC 26 provides coordinated control of the various BSs 32. The BSC 26 also communicatively couples the RAN 20 to the PCN 22.

The PCN 22 comprises a Packet Data Serving Node (PDSN) 38 that includes one or more controllers 40, or other processing systems, a Home Agent (HA) 42, and an Authentication, Authorization, and Accounting (AAA) server 44. Typically, the PCN 22 couples to the PDN 18 through a managed IP network 46, which operates under the control of the network 10. The PDSN 38 operates as a connection point between the RAN 16 and the PDN 18 by establishing, maintaining and terminating Point-to-Point Protocol (PPP) links, and further provides Foreign Agent (FA) functionality for registration and service of network visitors. HA 42 operates in conjunction with PDSN 38 to authenticate Mobile IP registrations and to maintain current location information in support of packet tunneling and other traffic redirection activities. Finally, AAA server 44 provides support for user authentication and authorization, as well as accounting services.

The BSC 26 also communicatively couples the RAN 20 to the IS-41 network 24. The IS-41 network 24 includes a Mobile Switching Center (MSC) 48 accessing a Home Location Register (HLR) 50 and Visitor Location Register (VLR) 52 for subscriber location and profile information. The MSC 48 establishes circuit-switched and packet-switched communications between the RAN 20 and the PSTN 16 and ISDN 16.

The forward link packet data channel (F-PDCH) is transmitted with all residual power. That is, the power remaining after transmitting the dedicated traffic channels and control channels is allocated to the F-PDCH. Each mobile station 12 returns a Channel Quality Indicator (CQI) on the reverse packet data control channel (R-PDCCH), from which the base station 32 calculates the highest data rate that mobile can receive. The base station 32 (or BSC 26) adjusts the data rate for packets on the F-PDCH, and schedules the packets for transmission according to a variety of schemes, such as round-robin, proportionally fair, or maximum throughput (also known as maximum carrier/interference).

On the reverse link, some or all of the mobile stations 12 in a sector may transmit simultaneously. Each mobile station's transmission is seen as noise by all other mobile stations 12 in the sector, requiring other mobile stations 12 to increase their transmit power to maintain an acceptable Signal to Interference and Noise Ratio (SINR) at the base station 32. To prevent all mobile stations 12 from continuously increasing their transmit power (which would eventually render the system unstable), the mobile stations 12 are power-controlled by the base station 32. Revision D to IS-2000 offers several mechanisms for the MAC of the R-PDCH to accomplish this: autonomous operation, per-sector and per-group common rate control (CRC), dedicated rate control (DRC) and grant assignments. Autonomous operation enables a mobile station 12 to transmit without requesting permission from the base station 32 up to an adjustable maximum Autonomous data rate. The remaining four mechanisms require active control by the base station 32 on one or more power control sub-channels or other forward link control channels.

In common rate control (CRC), the base station 32 sends rate control commands (UP, DOWN or HOLD) based on the current (and possibly a prediction of the near future) reverse link load and other factors. The rate control commands received from each sector in the active set of a mobile station 12 are combined, following the or-of-down's rule. That is, if any sector says DOWN, the combined command is DOWN; otherwise, if any sector says HOLD, the combined command is HOLD. Only when all sectors say UP can the combined command be the UP command. The UP, DOWN and HOLD commands refer to the reverse link data rate of the mobile station 12.

For each reverse link traffic channel, including the R-PDCH, the mobile station 12 receives the rate control commands and computes the maximum Traffic-to-pilot Power Ratio (TPR) that it can operate. Based on this, the mobile station 12 will decide the reverse link data rate. In order to compute the maximum allowed TPR, the mobile station 12 uses a TPR step size table. For example, if the received, combined command is UP, the mobile station 12 will look retrieve from the table the corresponding TPR step size increase. Once the maximum TPR is known, the mobile station 12 accesses another table called TPR table, that specifies the TPR associated with each reverse link supported rate. In this manner, the mobile station 12 determines the maximum reverse link data rate at which it can transmit.

The default values of the TPR table and TPR step size table are stored at the mobile station 12. These defaults may comprise values suggested in the standards based on simulations. To allow system operators to adjust these values based on field data and experience, the TPR table and TPR step size table values may be updated by the base station 32 via “Layer 3” signaling messages.

The forward rate control channel (F-RCCH), which is part of the forward indicator control channel (F-ICCH), conveys the rate control commands. The mobile station 12 is directed to which sub-channel to monitor via a layer 3 signaling message. The mobile station 12 then decodes the rate control commands every 10 ms. The rate control can be operated in two modes: per-sector CRC, or per-group CRC.

In per-sector CRC mode, a base station 32 sends only one CRC command for every time frame (10 ms) for the entire sector, and all the mobile stations 12 in the sector that are operating in the per-sector CRC mode monitor this single CRC command and adjust their reverse link transmit rate accordingly. In this case, regardless of the user class (e.g., Gold, Silver or Bronze) all mobile stations 12 are rate controlled with the same UP, DOWN or HOLD command.

Unlike per-sector CRC, where the reverse link data rates of multiple mobile stations 12 are adjusted by a single command, in per-group CRC mode, the base station 32 sends multiple CRC commands based on how many groups of mobile stations 12 are in the sector. Each group of mobile stations 12 is assigned to a separate F-RCCH sub-channel to monitor shared per-group CRC commands. In this case, it is possible to serve different classes of users with different rate control commands, e.g., Gold class user can be given more up and hold commands than that for the Silver and Bronze class users. That is, explicit user-class provisioning is possible with per-group CRC mode.

Dedicated rate control (DRC) adjusts the data rate of a single mobile station 12. DRC provides a finer degree of control over the reverse link transmission data rate of a mobile station 12, thereby adapting the reverse link more quickly to meet more stringent QoS requirements. The DRC procedure consists of status reporting by the mobile station 12 and rate adjustment by the base station 32. The mobile station 12 starts its transmission up to the maximum autonomous rate. Then, if the mobile station 12 has enough power headroom and an amount of buffered data that warrants a higher data rate, an indicator called Mobile Status Indicator Bit (MSIB) is set to 1 on the Reverse Packet Data Control Channel (R-PDCCH) to request rate increase. Upon receiving the MSIB, the base station 32 computes the relative priority of each mobile station 12 according to criteria such as system load and fairness. The base station 32 then sends UP, DOWN and HOLD commands in response to the MSIB. Unlike CRC, DRC immediately increases the data rate of the mobile station 12 to the next level by one UP command and vice versa by one DOWN command. That is (other than in soft handoff) no or-of-down's rule applies to DRC.

Grant assignments are yet another form of rate control supported by Revision D of IS-2000. The Grant assignment procedure also consists of mobile station 12 status reporting and base station 32 response, but with much more information. In Grant assignment, the mobile station 12 reports its status through Reverse Request Channel (R-REQCH), which includes the mobile station 12 power headroom, the buffer level and the associated service instance (corresponding to the traffic type and its QoS requirements). The base station 32 responds through the Forward Grant Channel (F-GCH), which includes the scheduled Medium Access Control Identification (MAC-ID) of the mobile station 12, the maximum packet size, and a persistence bit. Note that an ARQ channel identification may be taken from the time instance of the grant, rather than being explicitly included in the grant message. Rather than sending UP, DOWN or HOLD commands to incrementally manage the reverse link rate of the mobile station 12, the F-GCH is used to directly assign a maximum allowed data rate. A maximum date rate grant may persist until it is overwritten by another grant. Each mobile station 12 can monitor up to two F-GCH's.

Per-group CRC is the traditional approach to user class provisioning. The base station 32 may assign multiple mobile stations to a F-RCCH sub-channel, and rate control the mobile stations 12 with common (to that class) rate control commands. Mobile stations 12 not in the class may be assigned to another class (and assigned a different F-RCCH sub-channel), or may be per-sector common rate controlled. In this manner, the base station 32 may serve different class of users with different rate control commands, e.g., a Gold class user may be given more up and hold commands than the Silver or Bronze class users or the non-provisioned users. DRC and/or Grant assignments may also be used to provision users into QoS classes, by directly controlling or assigning all mobile stations 12 in a class to the same reverse link transmission data rate.

Per-group CRC, DRC and Grant assignments, however, consume forward link radio resources. Per-group CRC requires a separate F-RCCH sub-channel for each class of service (possibly in addition to a CRC sub-channel for non-provisioned users), and DRC requires a sub-channel for each mobile station 12 being dedicated rate controlled. Grant assignments require activity on the R-REQCH and F-GCH channels (again, in addition to a CRC sub-channel). All of these forward link control channels increase the forward link transmit power, robbing the F-PDCH channel of transmit power that could be applied to providing data services to users. Additionally, there is a higher overhead in assigning an individual rate control sub-channel for each group in the case of per-group CRC, and much greater overhead in directly controlling individual mobile stations 12 in the case of DRC or Grant assignments. Furthermore, all of the methods result in greater complexity at the base station 32, in computing the individual rate control commands for different groups. That is, in addition to the reverse link sector load (and possibly other factors), the BS also needs to take into account the fact that there are multiple group of users requiring different rate control commands or assignments.

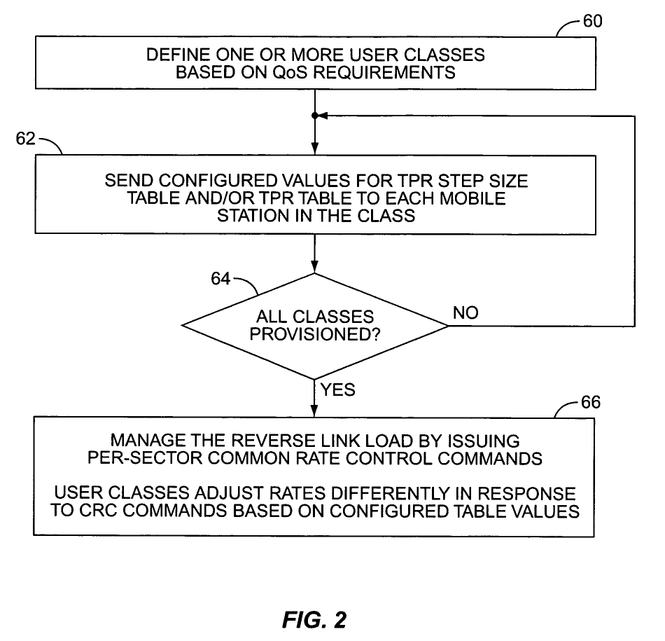

According to the present invention, QoS user class provisioning may be accomplished using only per-sector CRC commands, as depicted in FIG. 2. First, QoS-based user classes are defined (block 60) (e.g., Gold, Silver, Bronze). Configured values are sent to one or both of the TPR table and TRP step size table in each mobile station 12 in a given user class (block 62). Multiple classes may be provisioned by sending different configured table values to the mobile stations 12 in each class (block 64). The base station then manages the reverse link by issuing per-sector CRC commands (block 66). The mobile stations 12 in each class then adjust their data rates differently, in response to the common CRC commands (block 66).

For example, the mobile stations 12 of Gold class users may be altered via Layer 3 signaling to include large increase values in the TPR step size table. This will allow the Gold users to “ramp up” to a higher data rate more rapidly, when channel conditions are such that they receive all UP CRC commands. Similarly, the TPR step size table may be configured include small decrease values, to allow Gold users to “ramp down” more slowly upon receipt of one or more DOWN CRC commands. The Gold users may have configured values written to their TPR tables, allowing for a higher data rate at a given TPR level. The tables may be cooperatively configured to allow a mobile terminal 12 to quickly ramp up to a specified maximum data rate, and to require a larger number of DOWN commands before shifting to a lower data rate, as may be desirable for applications such as video conferencing, which require a relatively constant data rate. Silver and Bronze users' TPR tables and TPR step size tables may be configured to provide for slower ramp-up or ramp-down, different data rates at predetermined TPR levels, and the like.

The tables that are appropriate for effecting different user class response based on the application/service the user employs are predefined and available at the base station 32. These tables are sent to the mobile station 12 during service negotiation, and additionally may be updated during a call if necessary.

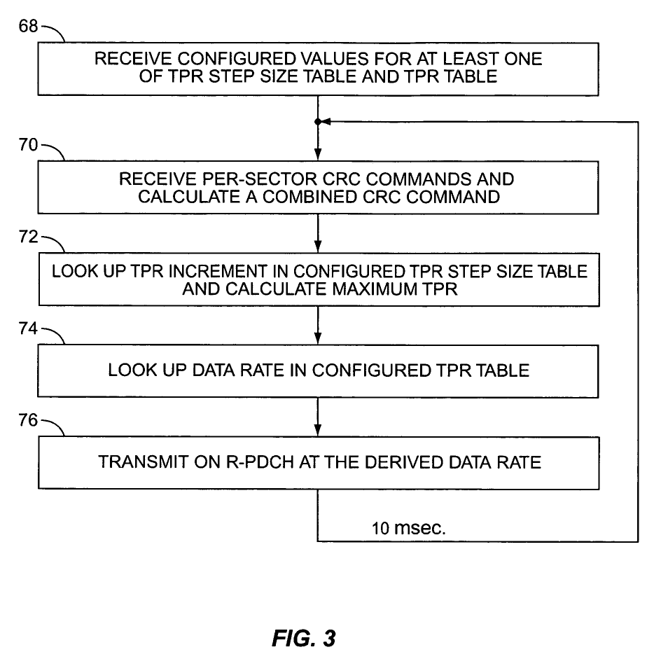

The per-sector CRC commands are issued by the base station 32 based on the reverse link load and possibly other factors. As depicted in FIG. 3, a mobile station 12 receives CRC commands from all sectors in its active set, and calculates a combined CRC command based on the or-of-downs rule (block 70). The mobile station 12 then accesses its configured TPR step size table to determine its maximum TPR (block 72). For example, if the received command is UP, the mobile station 12 performs a look-up in the configured TPR step size table to determine the positive TPR increment, which is added to the current TPR value. Once the maximum TPR is known, the mobile station 12 accesses its configured TPR table—which specifies the TPR associated with each supported reverse link rate—to determine its transmission data rate (block 74). The mobile station 12 then adjusts its data rate, if necessary, to the new rate, and transmits on the R-PDCH (block 76). The per-sector CRC commands are issued every 10 msec, and the process repeats.

In response to the same per-sector CRC commands, a Gold class mobile station 12 may have a higher target data rate, reach that target rate more quickly, and/or maintain that rate longer as the reverse channel load increases, as compared to a Silver class user, based on the configured table values. The Silver class user may have a lower target rate, take longer to ramp up to that target rate under low reverse channel loads, and ramp down from that rate more quickly as the reverse channel load increases, in response to the same per-sector CRC commands and its configured table values. Of course, the number of user classes that may be defined and implemented according to the present invention is not limited to the two or three discussed herein, and Gold, Silver and Bronze are merely terms of reference to distinguish the QoS or Grade-of-Service (GoS) user classes, and do not limit the present invention in any way.

The present invention provides a method to provision users into QoS-based classes using per-sector CRC commands. This provides significant advantages over traditional user class provisioning methods, such as requiring a lower overhead of forward link transmit power, which would be required to send multiple per-group CRC commands, or to send rate control or assignment commands to individual mobile stations 12. The present invention additionally reduces the overhead of forward link rate control sub-channel usage, in that only one rate control sub-channel is necessary, compared to the per-group CRC method which requires multiple rate control sub-channels to achieve the user class provisioning. Additionally, the complexity underlying CRC command calculations at the base station 32 may be reduced, and multiple group rates need not be independently calculated and controlled.

It should be noted that the use of differing TPRs and/or different TPR adjustment step sizes does not impose any requirements for creating different tables or adjustment values on the fly. On the contrary, a network entity, such as base station 32, can be provisioned to store different configuration values corresponding to the different user classes, such that provisioning a given mobile station with the configuration value(s) corresponding to its user class comprises determining (or setting) the mobile station's user class designation, and transmitting the corresponding stored configuration values to it. Thus, the base station 32 may store different TPR values corresponding to different user classes and/or may store different TPR adjustment step sizes. Either or both such class-specific values may be considered as the “different” configuration values that can be transmitted to different ones of the mobile stations to achieve different CRC command responses among the different mobile stations. Also, it should be noted that the reverse link load adjustment may exhibit greater latency, as compared to per-group common rate control.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of user class provisioning for a reverse traffic channel in a wireless communication system including a plurality of mobile stations, comprising:
defining at least two classes of users;
assigning a first user to a first class by transmitting a first predetermined value to the first user's mobile station;
assigning a second user to a second class by transmitting a second, different predetermined value to the second user's mobile station; and
managing reverse link traffic by issuing per-sector common rate control (CRC) commands, the first user's mobile station responding differently to said CRC commands than the second user's mobile station in response to said predetermined values.

2. The method of claim 1 wherein said first and second predetermined values are selected from a group consisting of TPR table values and TPR step size table values.

3. The method of claim 2 wherein said first user's mobile station increases its data rate on the reverse traffic channel faster than said second user's mobile station increases it data rate on the reverse traffic channel in response to UP commands in said CRC commands.

4. The method of claim 2 wherein said first user's mobile station increases transmits on the reverse traffic channel at a higher data rate than the second user's mobile station, in response to said CRC commands.

5. The method of claim 2 wherein said first user's mobile station maintains a data rate on the reverse traffic channel longer than the second user's mobile station, in response to DOWN commands in said CRC commands.

6. The method of claim 1 wherein said first and second values are transmitted to the mobile stations via layer 3 signaling.

7. A method of selective group rate control for a reverse traffic channel in a wireless communication system including a plurality of mobile stations, comprising:
transmitting to a select subset of said plurality of mobile stations a predetermined value; and
issuing per-sector common rate control (CRC) commands operative to alter the data rate of said subset of mobile stations differently than the data rate of others of said plurality of mobile stations in response to said predetermined value.

8. The method of claim 7 wherein said predetermined value comprises a TPR table value.

9. The method of claim 7 wherein said predetermined value comprises a TPR step size table value.

10. A wireless communication system, comprising:
a plurality of mobile stations, each including a TPR table and a TPR step size table, and each operative to transmit packet data on a reverse packet data channel (R-PDCH) at a rate dynamically determined by a reverse pilot channel (R-PICH) power and values in said TPR and TPR step size tables; and
at least one base station issuing per-sector common rate control (CRC) commands in at least one sector to control the the R-PDCH data rate of one or more of the mobile stations; and
said base station configured to effect different reverse link rate control command response behaviors between different ones of the mobile stations responding to the CRC commands by altering at least one of said TPR table and TPR step size table values.

11. The wireless communication system of claim 10 wherein said base station alters said TPR table and/or TPR step size table values via Layer 3 signaling commands.

12. A method of determining a data rate for transmitting data on a reverse traffic channel of a mobile station assigned to a user class, comprising:
receiving values for at least one of a TPR step size table and TPR table, said values configured to the user class to which the mobile station is provisioned;
receiving per-sector common rate control (CRC) commands from at least one sector in the active set;
calculating a combined CRC command;
in response to the combined CRC command; accessing a value in said TPR step size table and calculating a maximum TPR;
in response to the calculated maximum TPR, accessing a value in said TPR table to obtain a maximum data rate, said data rate dependent on said user class configured values; and
transmitting on said reverse traffic channel at said maximum data rate.

13. The method of claim 12 wherein all steps other than receiving configured values are repeated periodically.

14. A of method of effecting different reverse link rate control behaviors among a plurality of mobile stations receiving the same reverse link rate control commands comprising:
storing different configuration values defining different reverse link rate control command response behaviors; and
transmitting different ones of the configuration values to different ones in the plurality of mobile stations.

15. The method of claim 14, wherein storing different configuration values defining different reverse link rate control command response behaviors comprises storing, at an entity in a wireless communication network, different configuration values for different user classes.

16. The method of claim 15, wherein transmitting different ones of the configuration values to different ones in a plurality of mobile stations comprises determining the user class a particular mobile station is associated with, and transmitting the configuration values corresponding to that user class to that particular mobile station.

17. The method of claim 15, wherein the different user classes correspond to different reverse link Quality-of-Service or Grade-of-Service parameters, such that the different configuration values yield differing reverse link performance for mobile stations in different user classes.

18. The method of claim 14, wherein the different configuration values comprise different Traffic-to-Pilot Ratio (TPR) values or different TPR step size adjustment values, said TPR values and TPR step size adjustment values used by said mobile stations to respond to the reverse link rate control commands received by the mobile stations.
